(19) United States
(12) Patent Application Publication
(10) Pub. No.: US 2026/0341152 A1
(43) Pub. Date: Oct. 29, 2026

(54) SYSTEM FOR PROVIDING PARKING LOCATION INFORMATION AND METHOD THEREOF

(71) Applicants: HYUNDAI MOTOR COMPANY, Seoul (KR); Kia Corporation, Seoul (KR)

(72) Inventors: Soo Yeon SHIN, Hwaseong-si (KR); Hae Young KWON, Hwaseong-si (KR); Tae Hyun SUNG, Hwaseong-si (KR)

(73) Assignees: HYUNDAI MOTOR COMPANY, Seoul (KR); Kia Corporation, Seoul (KR)

(21) Appl. No.: 19/340,218

(22) Filed: Sep. 25, 2025

(30) Foreign Application Priority Data
Apr. 24, 2025 (KR) 10-2025-0054141

(51) Int. Cl. G08G 1/14; G06V 20/58; G06V 20/62; G06V 30/14

(52) U.S. Cl. CPC G08G 1/143; G06V 20/586; G06V 20/63; G06V 30/14

(57) ABSTRACT

Disclosed is a vehicle parking location information providing system including a vehicle including a vehicle control device that recognizes parking location information of a vehicle, an image capturing device placed in the vehicle, and a location measuring device placed in the vehicle. The vehicle control device acquires image data, which is obtained by capturing at least one exterior of the vehicle, from the image capturing device, acquires location data from the location measuring device, acquires a plurality of image frames from the image data, acquires text information included in the plurality of image frames, and acquires parking location information where the vehicle is parked, based on the acquired text information and the acquired location data.

### CROSS-REFERENCE TO RELATED APPLICATION

This application claims the benefit of priority to Korean Patent Application No. 10-2025-0054141, filed in the Korean Intellectual Property Office on Apr. 24, 2025, the entire contents of which are incorporated herein by reference in its entirety.

### TECHNICAL FIELD

The present disclosure relates to a device for providing parking location information of a vehicle, a system including the same, a method thereof, and more particularly, relates to a technology for providing parking location information of a vehicle based on text recognition.

### BACKGROUND

Many vehicle users often face difficulties recalling the precise location of their parked vehicles. This challenge is particularly evident in expansive parking spaces such as shopping malls, airports, or intricate urban parking facilities. Users typically rely on ambient information, which includes cues like signage describing the number of floors or specific location identifiers within the parking area. However, if a user is not entirely attentive to these details when parking, they may find it challenging to remember where their vehicle is located upon return. This lack of awareness can lead to frustration and anxiety, especially when navigating vast parking complexes. The problem intensifies in larger venues, where the sheer size and complexity of the parking layout can overwhelm even the most attentive user. For example, the user may leave the parking lot without a clear mental map of their vehicle's position. Recognizing these difficulties highlights the need for innovative solutions to assist users in navigating parking facilities.

For instance, the current system used by service providers for parking facilities separates parking location information from the users' ability to access it instantly. This limitation necessitates users to engage with an additional device to ascertain their vehicle's parking location after it has been parked. Consequently, locating a vehicle in this manner imposes considerable inconvenience, particularly in dynamic environments where users may be traversing the parking lot.

Real-time tracking is not merely a convenience; it is essential for enhancing the overall parking experience. Users often find themselves frustrated as they lack immediate access to vital information regarding their vehicle's whereabouts. As they move around the parking lot, the ability to seamlessly check the location of their vehicle becomes increasingly important.

To address these challenges, there is a pressing need for an improved parking location notification system. Such a system should enable users to effortlessly recognize their vehicle's location based on their current position, eliminating the need for a cumbersome verification process.

### SUMMARY

An aspect of the present disclosure provides a system for providing parking location information for directly identifying a vehicle's parking location information by utilizing image information, and a method thereof.

An aspect of the present disclosure provides a system for providing parking location information that recognizes vehicle location and provides a notification such that a user recognizes a parking location, and a method thereof.

The technical problems to be solved by the present disclosure are not limited to the aforementioned problems, and any other technical problems not mentioned herein will be clearly understood from the following description by those skilled in the art to which the present disclosure pertains.

According to an aspect of the present disclosure, a vehicle parking location information providing system includes a vehicle including a vehicle control device that recognizes parking location information of the vehicle, an image capturing device placed in the vehicle, and a location measuring device placed in the vehicle.

In an embodiment, the vehicle control device acquires image data, which is obtained by capturing at least one exterior of the vehicle, from the image capturing device, acquires location data from the location measuring device, acquires a plurality of image frames from the image data, acquires text information included in the plurality of image frames, and acquires parking location information where the vehicle is parked, based on the acquired text information and the acquired location data.

In an embodiment, the vehicle control device may transmit the acquired parking location information to a user device operating in conjunction with the vehicle control device.

In an embodiment, the user device operating in conjunction with the vehicle control device may be a user device operating in conjunction with a user profile stored in the vehicle control device.

In an embodiment, the vehicle parking location information providing system further includes a display placed inside the vehicle.

In an embodiment, the vehicle control device displays a message including the acquired parking location information via the display.

In an embodiment, the message including the parking location information further includes a selection button for modifying the parking location information.

In an embodiment, the parking location information includes floor information where the vehicle is parked, and zone information where the vehicle is parked.

In an embodiment, the vehicle control device acquires valid text information associated with at least one of a floor of a parking lot or a zone of the parking lot among the text information, and acquires the parking location information based on the valid text information and the location data.

In an embodiment, the vehicle control device excludes text information including an arrow among the text information from the valid text information.

In an embodiment, the vehicle control device acquires driving information of the vehicle and acquire the valid text information based on the driving information, or acquires information about a type of parking lot where the vehicle is located, and acquire the valid text information based on the information about the type.

In an embodiment, the vehicle control device acquires the text information based on an Optical Character Recognition (OCR) model.

In an embodiment, the vehicle location information providing system further includes an illumination sensor.

In an embodiment, the vehicle control device activates the OCR model based on data acquired from the illumination sensor.

In an embodiment, the vehicle includes a gear for changing a driving mode.

In an embodiment, the vehicle control device activates the OCR model based on a movement of the gear.

In an embodiment, the vehicle control device reverses play the acquired image data while the gear is positioned in a parking mode, and acquires the plurality of image frames while the image data is reversely played.

In an embodiment, the location data further includes time information.

In an embodiment, the vehicle control device matches the location data with the image data by using a time stamp.

In an embodiment, the vehicle control device acquires text information included in a predetermined number of consecutive image frames among the plurality of image frames, and determines whether a location of the vehicle is changed, based on text information included in the predetermined number of the consecutive image frames.

In an embodiment, the vehicle control device acquires location data corresponding to at least two image frames among the plurality of image frames, and determines whether the location of the vehicle is changed, during the time section based on the location data corresponding to the at least two image frames.

In an embodiment, the vehicle control device acquires the parking location information based on the determination result of whether the location of the vehicle is changed based on the text information, and the determination result of whether the location of the vehicle is changed based on the location data.

According to an aspect of the present disclosure, a parking location recognizing method performed by a vehicle control device included in a vehicle includes acquiring image data, which is obtained by capturing at least one exterior of the vehicle, from an image capturing device placed in the vehicle, acquiring a plurality of image frames from the image data, acquiring text information included in the plurality of image frames, acquiring location data of the vehicle from a location measuring device placed in the vehicle, and acquiring parking location information where the vehicle is parked, based on the acquired text information and the location data.

In an embodiment, the method further includes transmitting the acquired parking location information to a user device operating in conjunction with the vehicle control device.

In an embodiment, the user device operating in conjunction with the vehicle control device may be a user device operating in conjunction with a user profile stored in the vehicle control device.

In an embodiment, the method further includes displaying a message including the acquired parking location information via a display placed in the vehicle.

In an embodiment, the message including the parking location information further includes a selection button for modifying the parking location information.

### BRIEF DESCRIPTION OF THE DRAWINGS

The above and other objects, features and advantages of the present disclosure will be more apparent from the following detailed description taken in conjunction with the accompanying drawings:

FIG. 1 is a block diagram schematically illustrating a system providing parking location information, according to an embodiment of the present disclosure;

FIG. 2 conceptually illustrates a parking location information providing service, according to an embodiment of the present disclosure;

FIG. 3 is a flowchart schematically illustrating a vehicle parking location recognition and notification procedure, according to an embodiment of the present disclosure;

FIG. 4 is a flowchart conceptually illustrating an operation mechanism for recognizing a parking location of a vehicle and providing parking location information, according to an embodiment of the present disclosure;

FIG. 5 is a flowchart illustrating a method for providing parking location information of a vehicle, according to an embodiment of the present disclosure;

FIG. 6 is a flowchart of a parking location recognition method if a recognition model is operated during driving, according to an embodiment of the present disclosure;

FIG. 7 is a flowchart of a parking location recognition method if a recognition model is operated after parking, according to an embodiment of the present disclosure;

FIG. 8 is a flowchart of a method for recognizing a parking location, according to an embodiment;

FIG. 9 is a drawing for describing OCR results, according to an embodiment of the present disclosure;

FIG. 10 is a flowchart of a method for recognizing a parking location, according to an embodiment;

FIG. 11 is a flowchart of a method for recognizing a parking location, according to an embodiment;

FIG. 12 is an example of an interface that displays parking location information on a user device or a vehicle terminal, according to an embodiment of the present disclosure; and

FIG. 13 illustrates a computing system according to an embodiment of the present disclosure.

### DETAILED DESCRIPTION

Hereinafter, some embodiments of the present disclosure will be described in detail with reference to the accompanying drawings. In adding reference numerals to components of each drawing, it should be noted that the same components include the same reference numerals, although they are indicated on another drawing. Furthermore, in describing the embodiments of the present disclosure, detailed descriptions associated with well-known functions or configurations will be omitted if they may make subject matters of the present disclosure unnecessarily obscure.

In describing elements of an embodiment of the present disclosure, the terms first, second, A, B, (a), (b), and the like may be used herein. These terms are only used to distinguish one element from another element, but do not limit the corresponding elements irrespective of the nature, order, or priority of the corresponding elements. Furthermore, unless otherwise defined, all terms used herein, including technical or scientific terms, include the same meaning as commonly understood by one of ordinary skill in the technical field to which the present disclosure belongs. It will be understood that terms used herein should be interpreted as including a meaning that is consistent with their meaning in the context of the present disclosure and the relevant art and will not be interpreted in an idealized or overly formal sense unless expressly so defined herein.

In a precision positioning technology, accuracy is reduced in environments such as tunnels, multipaths, and parking lots other than open areas, where Global Positioning System (GPS) sensors function well, because Dead Reckoning (DR) prediction values are used. In particular, altitude values are less accurate, and thus it is difficult to be used to determine floors. Pre-built maps or highly precise positioning technology may be used to determine a location within a parking lot, but this is costly and time-consuming.

Optical Character Recognition (OCR) is a technology of extracting text from images or scanned documents and converting the text into digital text. The OCR may be applied to derive data of standardized formats or static images such as documents or barcode scans.

The present disclosure relates to a device/method for estimating a location of a vehicle based on image data and location data of the vehicle collected in real time by using text recognition technology such as OCR, and providing parking location information such that a user may easily find the vehicle.

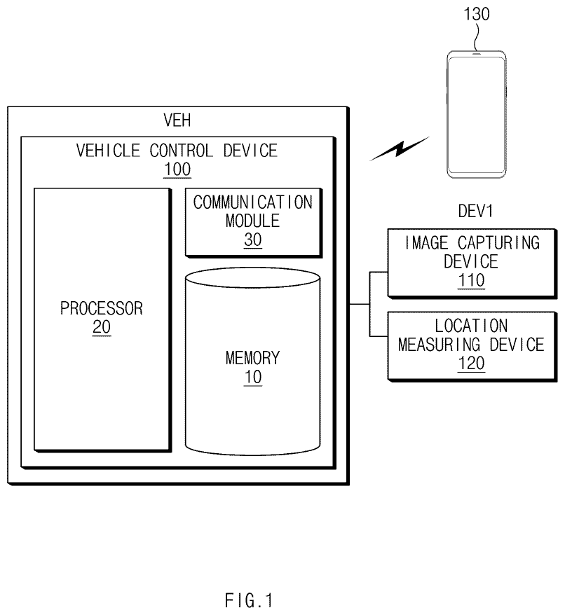

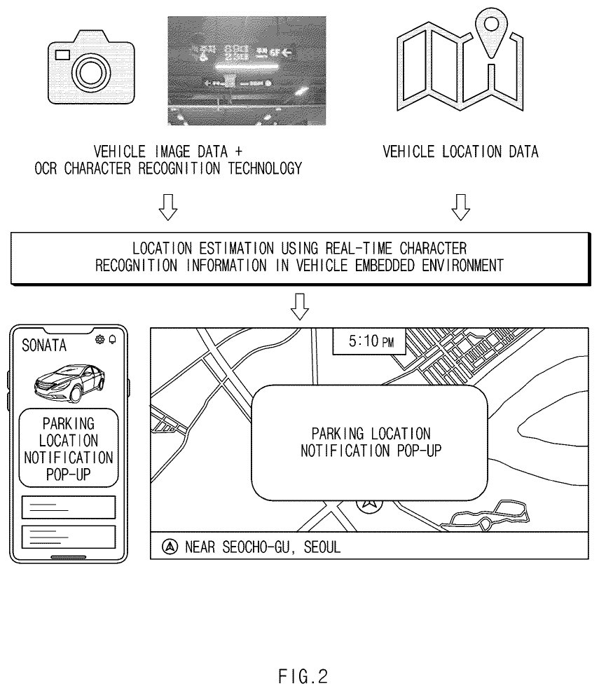

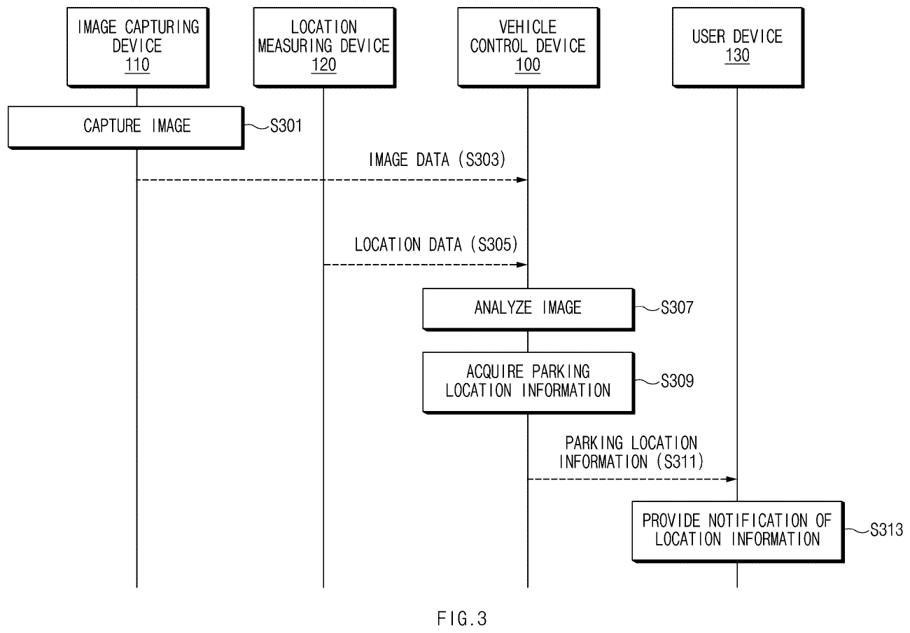

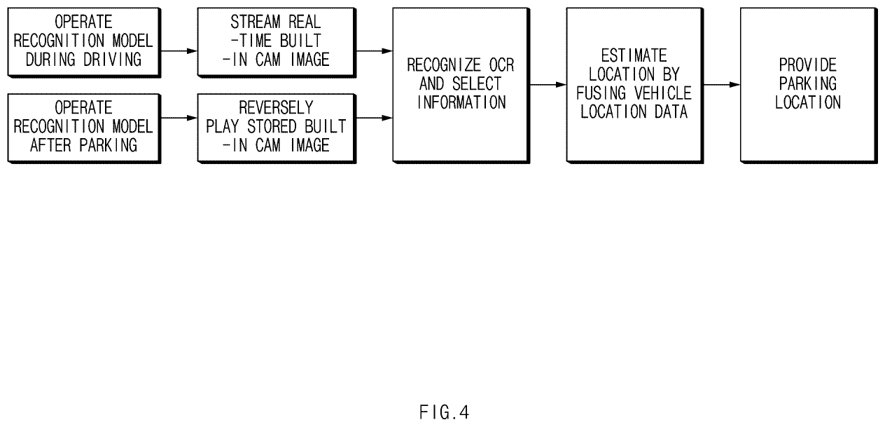

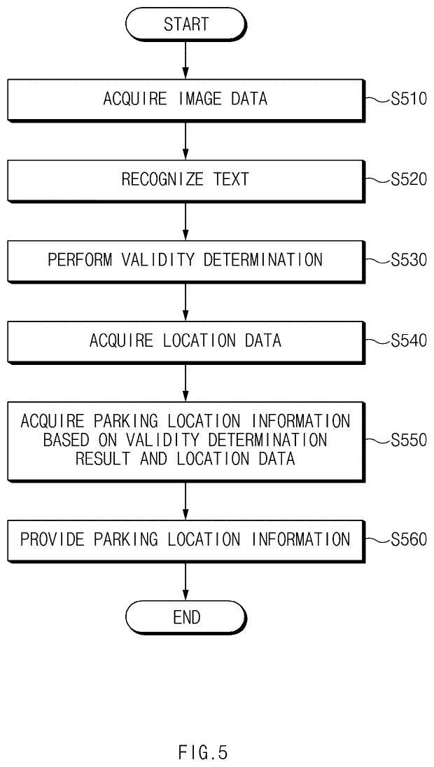

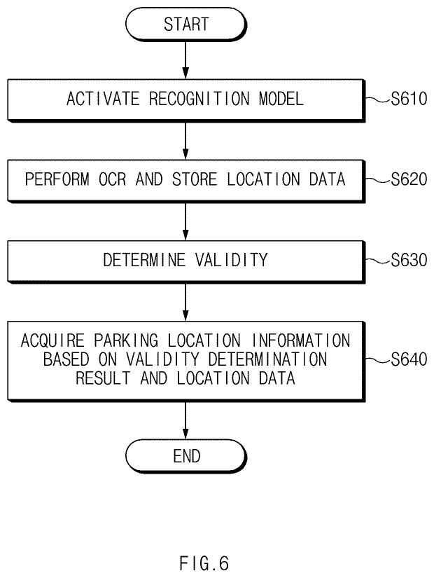

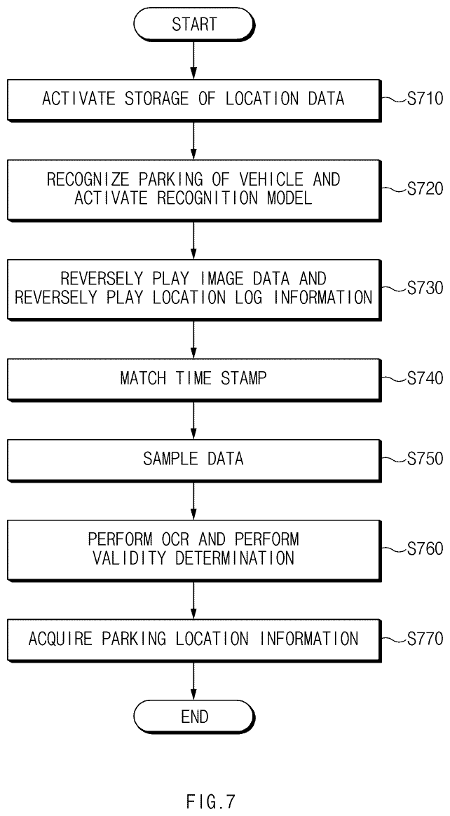

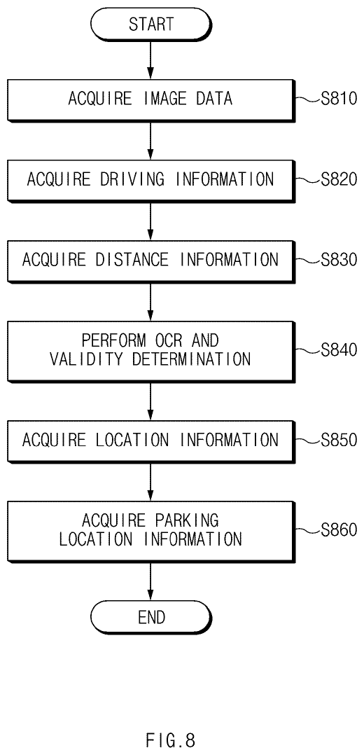

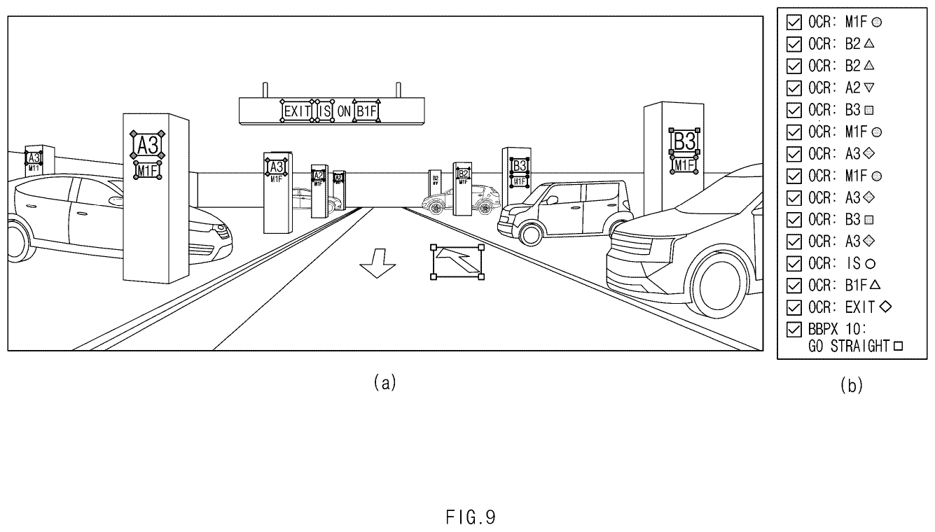

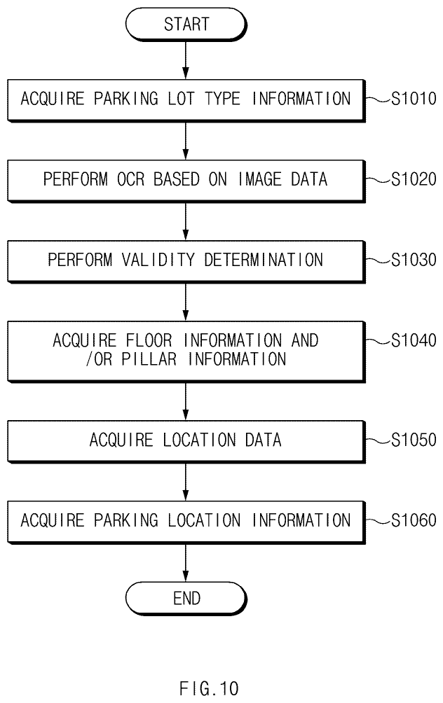

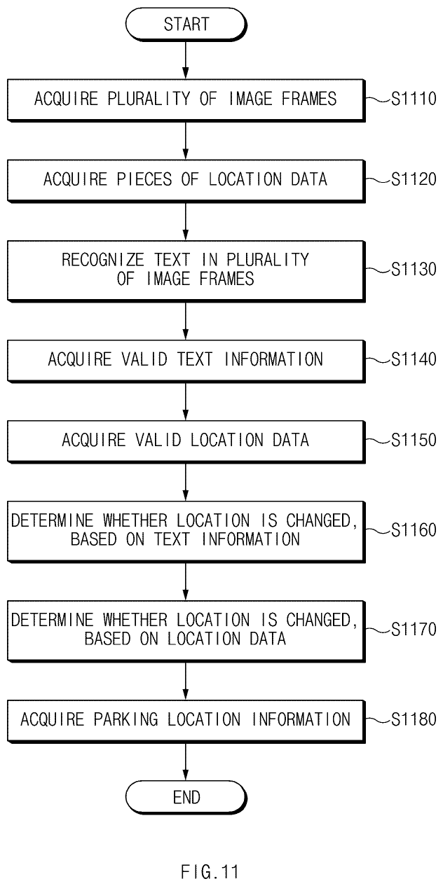

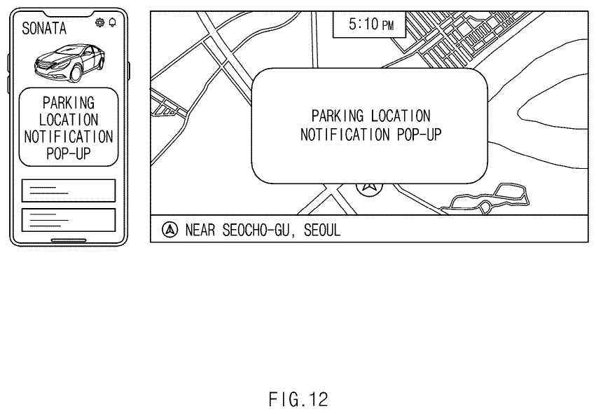

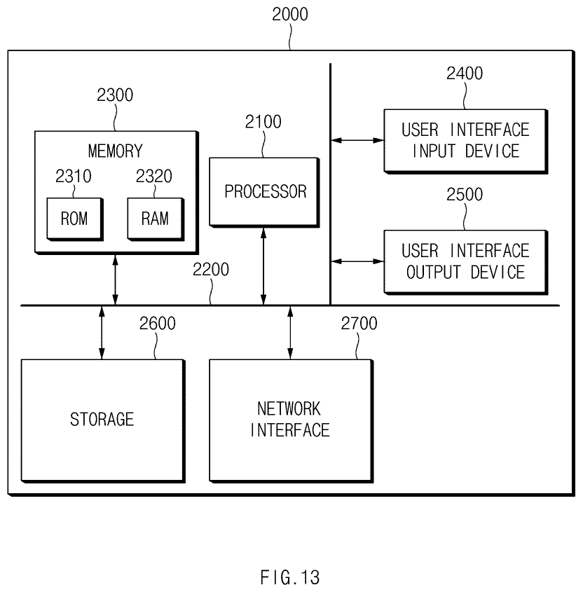

Hereinafter, embodiments of the present disclosure will be described in detail with reference to FIG. 1, FIG. 2, FIG. 3, FIG. 4, FIG. 5, FIG. 6, FIG. 7, FIG. 8, FIG. 9, FIG. 10, FIG. 11, FIG. 12, and FIG. 13.

FIG. 1 is a block diagram schematically illustrating a system providing parking location information, according to an embodiment of the present disclosure.

Referring to FIG. 1, a system for providing parking location information of a vehicle includes at least one of a vehicle control device 100, an image capturing device 110, a location measuring device 120, or a user device 130.

A vehicle location information providing service provided in the vehicle location information providing system may be defined as a service that provides parking location information such that users of vehicles may directly recognize and easily identify the location of mobility such as a vehicle in an environment such as a parking lot where it is difficult to determine the location.

The vehicle control device 100 includes a management device that is placed at a vehicle terminal and connected via an In-Vehicle Network (IVN). The IVN may be implemented with Controller Area Network (CAN), a Media Oriented Systems Transport (MOST) network, Local Interconnect Network (LIN), Ethernet, and/or X-by-Wire (FlexRay).

The vehicle control device 100 acquires surrounding data for estimating the location of the vehicle via a plurality of auxiliary devices mounted on the vehicle, such as the image capturing device 110 or the location measuring device 120, and may generate parking location information of the vehicle by processing the surrounding data. The vehicle control device 100 samples an image while playing or reversely playing image data acquired from the image capturing device 110, and performs text recognition by using the sampled image. The vehicle control device 100 may increase the accuracy of estimated parking location information by using location data acquired from the location measuring device 120 together with acquired image data or video data.

The image capturing device 110 refers to a device capable of collecting images of external environments of a vehicle, such as a black box or a camera for autonomous driving, and delivers the collected vehicle image data to the vehicle control device 100. In FIG. 1, the image capturing device 110 is expressed as an independent device distinct from the vehicle control device 100, but the image capturing device 110 may also be implemented in a form integrated into the vehicle control device 100. The image capturing device 110 may be implemented as a Drive Video Record System (DVRS), a rear camera, a front camera, or the like.

The location measuring device 120 acquires location data and delivers the acquired location data to the vehicle control device 100. The location data includes various types of data for identifying the location of the vehicle, such as precise positioning technology, map matching data, and destination Point of Interest (POI).

In FIG. 1, the location measuring device 120 is expressed as an independent device distinct from the image capturing device 110 and the vehicle control device 100, but may also be implemented in a form integrated into the image capturing device 110 or the vehicle control device 100. A location measuring device for acquiring a vehicle control device may be implemented, for example, by a Global Navigation Satellite System (GNSS) such as GPS, an Inertial Measurement Unit (IMU), a Real-Time Location System (RLTS), or a Digital Tacho Graph (DTG).

The vehicle control device 100 includes a memory 10, a processor 20, and a communication module 30.

The memory 10 may store software programmed for the processor 20 to perform the predetermined operation. Moreover, the memory 10 may store image data, location data, or the like, which is acquired from the image capturing device 110 or the location measuring device 120.

The memory 10 may be implemented as an Embedded MultiMediaCard (eMMC). The memory 10 may store system software, application software (e.g., navigation map software), and firmware.

The memory 10 may be implemented with at least one storage medium (recording medium) among a flash memory, a hard disk, a Secure Digital (SD) card, a Random Access Memory (RAM), a Static Random Access Memory (SRAM), a Read Only Memory (ROM), a Programmable Read Only Memory (PROM), an Electrically Erasable and Programmable ROM (EEPROM), an Erasable and Programmable ROM (EPROM), a register, or a removable disc. The memory 10 may store the profile of the user device 130 operating in conjunction with a vehicle (or the vehicle control device 100). That is, the user device operating in conjunction with a vehicle may mean the user device operating in conjunction with a profile.

The processor 20 controls the overall operations of the vehicle control device 100. The processor 20 may control the overall operation of the vehicle terminal and may be implemented with at least one of an Application Specific Integrated Circuit (ASIC), a Digital Signal Processor (DSP), a Programmable Logic Devices (PLD), Field Programmable Gate Arrays (FPGAs), a Central Processing Unit (CPU), a micro-controller, or a microprocessor. The processor 20 may be manufactured in a package integrated with the memory 10 (i.e., eMMC). Furthermore, the processor 20 includes a Random Access Memory (RAM), a Static Random Access Memory (SRAM), a Read Only Memory (ROM), a Programmable Read Only Memory (PROM), an Electrically Erasable and Programmable ROM (EEPROM), an Erasable and Programmable ROM (EPROM), and/or a register.

The processor 20 may process image data and location data acquired from the image capturing device 110 and the location measuring device 120, and may generate parking location information. The processor 20 may extract text included in the image data or image data being a part of the image data by using the image data, and recognizes the text. The processor 20 may select only valid text from the recognized text. The processor 20 may estimate the parking location of a vehicle by using the selected valid text and location data and may generate parking location information.

The processor 20 displays the generated parking location information via a display (not shown). Furthermore, the processor 20 may allow the communication module 30 to transmit the generated parking location information to the user device 130 operating in conjunction with the vehicle (or the vehicle control device 100).

The communication module 30 transmits and receives data via the IVN. The communication module 30 communicates with auxiliary devices (e.g., the image capturing device 110 and the location measuring device 120) via the IVN.

The communication module 30 exchanges data (information) with the user device 130 via wireless communication. Wireless LAN (WLAN) (Wi-Fi), Wireless broadband (Wibro), Long Term Evolution (LTE), International Mobile Telecommunication (IMT)-2020, Bluetooth, and/or Near Field Communication (NFC) may be used for wireless communication technologies.

The communication module 30 includes an access point (AP) serving as a bridge between the IVN and the wireless communication network, and a modem for accessing (connecting) the wireless communication network. The IVN may be implemented with Controller Area Network (CAN), a Media Oriented Systems Transport (MOST) network, Local Interconnect Network (LIN), Ethernet, and/or X-by-Wire (Flexray).

FIG. 2 conceptually illustrates a parking location information providing service, according to an embodiment of the present disclosure.

Referring to FIG. 2, a vehicle control device (e.g., the vehicle control device 100 of FIG. 1) according to an embodiment estimates a parking location of a vehicle based on location data of the vehicle and image data obtained by the vehicle itself, and provides the parking location to a user device operating in conjunction with the vehicle. Furthermore, the parking location may be displayed on a display installed in the vehicle such that a user immediately recognizes the parking location via the vehicle that the user is using. To this end, the vehicle control device may extract text included in image data and may select valid text indicating a parking zone or a parking floor.

In this way, the vehicle parking location information providing service may operate in a vehicle embedded environment, and may improve the user's parking convenience by estimating the parking location by using real-time text recognition information.

FIG. 3 is a flowchart schematically illustrating a vehicle parking location recognition and notification procedure, according to an embodiment of the present disclosure.

Referring to FIG. 3, the image capturing device 110 acquires an image of a vehicle (S301), and may transmit the acquired image to the vehicle control device 100 in real time, or transmit an image or a partial image obtained by sampling the image to the vehicle control device 100 (S303). In the meantime, the location measuring device 120 acquires location data of the vehicle and may transmit the acquired location data to the vehicle control device 100 (S305). The vehicle control device 100 may analyze the image acquired from the image capturing device 110 (S307) and acquires parking location information (S309). The vehicle control device 100 may transmit the acquired parking location information to the user device 130 (S311). The user device 130 may provide a user with the parking location information in the form of a notification (S313), and the user may immediately identify the parking location information of the parked vehicle via the user device 130, which is held by the user, due to the notification.

FIG. 4 is a flowchart conceptually illustrating an operation mechanism for recognizing a parking location of a vehicle and providing parking location information, according to an embodiment of the present disclosure.

Referring to FIG. 4, an Optical Character Recognition (OCR) model or an OCR method for recognizing a vehicle parking location may be implemented in a manner that operates during driving or after parking. A method of operating in real time during driving refers to a method of streaming image data acquired from an image capturing device (e.g., the image capturing device 110 of FIG. 1) in real time, and immediately performing, by a vehicle control device (e.g., the vehicle control device 100 of FIG. 1), recognition by using the streamed image. A method of operating a recognition model after parking refers to a method of reversely playing the image data acquired from the image capturing device and recognizing text from the played image.

The vehicle control device acquires vehicle image data in real time and acquires text information within a driving environment by using the OCR model capable of being utilized within an embedded environment. The vehicle control device recognizes text by using the OCR model, selects valid text information from the acquired text information if acquiring text information, estimates an optimal parking location by fusing vehicle location data and the valid text information, and acquires parking location information. The vehicle control device provides the acquired parking location information to the user device.

FIG. 5 is a flowchart illustrating a method for providing parking location information of a vehicle, according to an embodiment of the present disclosure.

Referring to FIG. 5, it shows a method for providing parking location information of a vehicle performed by a vehicle control device (e.g., the vehicle control device 100 of FIG. 1). In the following description, operations of the vehicle control device may be understood as being implemented by a processor.

In S510, the vehicle control device acquires image data. The vehicle control device acquires image data from an image capturing device (e.g., a black box) placed in the vehicle. The image data may be an image captured by the black box, and may be one of original image data, sampling image data obtained by sampling the original image data, or a sampled image. The image data includes image data corresponding to a plurality of frames.

In S520, the vehicle control device recognizes text included in the image data based on the acquired image data. The text includes at least one of text or a number. An operation of recognizing text based on the image data includes an operation of acquiring a plurality of images (or image frames) corresponding to a plurality of frames among the image data, extracting text included in the corresponding image, from each of the plurality of images or an object related thereto, and identifying or classifying the extracted text or object. In this process, each text or object is determined to correspond to a certain text, and thus text information is acquired.

A single image includes a plurality of texts. Accordingly, the vehicle control device recognizes pieces of text for each image and acquires the recognized text information. For convenience of description, at least one piece of text information acquired from a first image may be referred to as first text information, and at least one piece of text information acquired from a second image may be referred to as second text information.

The vehicle control device recognizes a text combination with respect to an image. The vehicle control device may be a concept in which one or more pieces of text information included in one image or a plurality of images include a combination of texts.

In S530, the vehicle control device performs a validity determination on the recognized text. The vehicle control device performs the validity determination on text information acquired from at least one image (or image frame).

The validity determination may be applied to a method of various embodiments described below, but in addition to those mentioned, various methods for determining the validity of acquired text information may be applied to the present disclosure.

In S540, the vehicle control device acquires location data of the vehicle. For example, the image capturing device such as a black box may support a location positioning technology. For example, the image capturing device includes a Global Positioning System (GPS) module internally. The vehicle control device acquires the location data from the image capturing device or a separate location measuring device. In some cases, the location measuring device may be integrated with the vehicle control device.

In an embodiment, the location data may be hourly location data. The location data includes pieces of location data or real-time location data, which is acquired while the vehicle is moving.

In FIG. 5, the acquisition of the location data is described as following S530, but the vehicle control device acquires location data in real time, and thus the location data is not limited to acquiring at a specific point in time.

In S550, the vehicle control device acquires parking location information based on the validity determination result and the location data. The vehicle control device acquires valid text information among pieces of text information via the validity determination. The valid text information may relate to text included in an image captured in a zone adjacent to the parking space of the vehicle.

The parking location information refers to estimation information obtained by estimating a location where a user parks the vehicle. For example, the parking location information includes information about a floor where the vehicle is estimated to be parked, and information about a zone where the vehicle is parked.

The vehicle control device may improve the accuracy of the vehicle's parking location information by utilizing location data as well as OCR and the validity determination result.

An operation of acquiring parking location information based on the validity determination result and location data includes an operation of acquiring parking location information based on location data at a specific point in time corresponding to valid text information acquired as the validity determination result among location data. The parking location information may be accurately calculated by utilizing location data acquired at a time point, at which an image frame including valid text information is captured, or at a time point adjacent thereto.

In S560, the vehicle control device may transmit the acquired parking location information to a user device operating in conjunction with the vehicle control device. The user device acquires parking location information and displays a notification message indicating the parking location via a display.

This means that the vehicle control device directly identifies a location, at which the vehicle is parked, and provides a notification to a user, and thus the user may identify the parking location via the user device without using a separate device to find the parking location. Accordingly, the user's accessibility to vehicle parking location information may be improved.

FIG. 6 is a flowchart of a parking location recognition method if a recognition model is operated during driving, according to an embodiment of the present disclosure.

Referring to FIG. 6, a vehicle control device (e.g., the vehicle control device 100 of FIG. 1) activates a recognition model if certain requirements are satisfied during driving, and performs OCR. Hereinafter, a case where a recognition model is activated from an entry time point if the vehicle control device recognizes entry into a parking lot will be described. It is assumed that a vehicle is receiving vehicle image data in real time from an image capturing device during driving. Furthermore, in the following description, operations of the vehicle control device may be understood as being implemented by a processor.

In S610, the vehicle control device activates an OCR model. If recognizing the entry into a parking lot, the vehicle control device activates the OCR model. The vehicle control device recognizes the entry into the parking lot based on whether precise positioning map matching fails if there is a destination POI, whether an entrance link is matched, and/or whether illumination sensor data changes.

For example, an illumination sensor may be placed inside the vehicle, and the vehicle control device activates the OCR model based on data acquired from the illumination sensor.

If recognizing a parking lot entry, the vehicle control device may trigger an OCR model operation or an OCR operation after a parking lot entry time point, or, after a time point at which location estimation is required if text-based location estimation is required. Resource utilization in embedded environments may be minimized by activating the OCR model under specific conditions.

However, even before the vehicle control device activates the OCR model, the vehicle is still driving, and thus the vehicle control device acquires image data captured in real time from an image capturing device.

In S620, the vehicle control device performs OCR based on triggering of the OCR operation or the OCR model. The vehicle control device may store OCR and vehicle location data from a time point (hereinafter referred to as a “parking lot entry time point”) at which entry into a parking lot is recognized. The vehicle location data includes at least one of the vehicle's latitude information, longitude information, or altitude information.

The vehicle control device performs OCR at regular intervals from the entry time point. For example, the vehicle control device performs the OCR by using the acquired image data at regular intervals such as 300 ms and may store the vehicle's location data (latitude, longitude, and altitude values) for each frame. The vehicle control device samples image frames at regular intervals if performing OCR, and performs OCR on the sampled image frames.

In S630, the vehicle control device performs a validity determination on the recognized text. In S640, the vehicle control device acquires parking location information based on the validity determination result and location data. In addition, the operation of the vehicle may be performed in a method of combining or modifying other embodiments of the present disclosure.

In the meantime, it is highly likely that the user will no longer use the resource after parking, (e.g., a case where the user puts the vehicle in park), and thus a method of implementing the OCR model from the corresponding time point may be applied for efficient resource utilization.

FIG. 7 is a flowchart of a parking location recognition method if a recognition model is operated after parking, according to an embodiment of the present disclosure.

Referring to FIG. 7, a vehicle control device (e.g., the vehicle control device 100 of FIG. 1) performs OCR on image data by utilizing image data stored after parking. In the following description, operations of the vehicle control device may be understood as being implemented by a processor.

In S710, the vehicle control device may store a vehicle's location data in advance. If it is difficult to estimate the vehicle's location via precise positioning (i.e., if it is determined that location estimation via an OCR model is necessary), the vehicle control device may store the vehicle's location data in advance in a form of log information. This is referred to as “location log information”. The location data is stored along with time information. A memory may store location data such as latitude, longitude, and altitude together with a time stamp.

The vehicle control device may store location data in advance if detecting entry into a parking lot. The vehicle control device recognizes the entry into the parking lot based on whether precise positioning map matching fails if there is a destination POI, whether an entrance link is matched, and/or whether illumination sensor data changes. In this case, the vehicle is still driving, and thus the vehicle control device acquires and store image data captured in real time from an image capturing device.

In S720, the vehicle control device recognizes the parking of the vehicle. The vehicle according to an embodiment of the present disclosure includes a gear for changing a driving mode, such as a drive mode or a parking mode. The vehicle control device recognizes a parking state or a parking mode of the vehicle based on the movement of a gear or a gear location.

The vehicle control device recognizes an operation of shifting the gear to P-gear (parking mode) and activates the OCR model.

The vehicle control device activates the OCR model, and in the S730, the vehicle control device reverses play pre-stored images. The vehicle control device reverses play image data and may also reversely play location log information.

That is, the vehicle control device reverses play the acquired image data while the gear is located in the parking mode.

In S740, the vehicle control device matches a time stamp with the location log information and the image data being reversely played. The vehicle control device normalizes a time stamp between the image data and the location log information, and matches the image data with the location data based on matching criteria. The vehicle control device matches the location data with an image frame of the image data based on the time stamp.

In S750, the vehicle control device samples the image data and the location data. The vehicle control device samples the matched image data and the matched location data based on the time stamp. While the image data and location data are being reversely played, the vehicle control device performs data sampling. The vehicle control device performs data sampling at regular intervals (or cycles) (e.g., 300 ms). The vehicle control device samples the image data and acquires the location data corresponding to each time point matching the sampled image data.

Unlike forward-playback images being played in a direction of time flow, sampling is required in a reverse-playback scenario being played in an opposite direction of time flow. In the case of forward-playback images being streamed in real time, an image is naturally sampled and vehicle location information at the corresponding time point is acquired. In the case of reverse-playback images, if all images acquired from the image capturing device are recognized, the recognition effect may be reduced due to duplicate recognition for consecutive scenes, and thus sampling for a specific period and matching with a location information log time point are required. The image sampling is very important because there is a time constraint from parking to termination of an embedded board.

In S760, the vehicle control device performs OCR by using sampled image data and performs a validity determination on the acquired text information. As a result of validity determination, the vehicle control device acquires valid text information, and acquires location data corresponding to a time point corresponding to the valid text information among pieces of location data corresponding to the sampled time point. The time point corresponding to the valid text information may mean a time point corresponding to (or matching) a time stamp of image data including the valid text information. The location data corresponding to the valid text information may be referred to as “valid location data”.

In S770, the vehicle control device acquires parking location information based on the validity determination result and the valid location data. Afterwards, the vehicle control device transmits the acquired parking location information to a user device.

FIG. 8 is a flowchart of a method for recognizing a parking location of a vehicle, according to an embodiment.

Referring to FIG. 8, a vehicle control device (e.g., the vehicle control device 100 of FIG. 1) may further utilize movement distance information if recognizing a parking location. In the following description, operations of the vehicle control device may be understood as being implemented by a processor.

In S810, the vehicle control device acquires image data, which is acquired from an image capturing device during driving, from the image capturing device. The vehicle control device samples the acquired image data and acquires image data.

In S820, the vehicle control device acquires driving information including at least one of vehicle speed or driving time while a vehicle is driving. While performing image sampling from the image data, the vehicle control device acquires the driving information.

In S830, the vehicle control device acquires distance information based on the driving information. The vehicle control device acquires information about a distance by which the vehicle moves during a predetermined time.

In S840, the vehicle control device performs OCR and validity determination. If performing validity determination, the vehicle control device may further utilize the distance information. The vehicle control device acquires floor determination information by using the acquired distance information. The vehicle control device performs a validity determination based on the floor determination information and text information acquired via an OCR. Besides, the validity determination method may refer to other embodiments described in the present disclosure.

In S850, the vehicle control device acquires location information corresponding to valid text information. In S860, the vehicle control device acquires parking location information based on the location information and the valid text information. The location information corresponding to the valid text information may mean location information matching a time at which an image frame including the corresponding text information is captured.

In this way, in a process of sampling the image to be input to a recognition model among driving images, the vehicle control device may calculate a distance suitable for floor determination by using information such as vehicle speed and driving time, and may utilize the calculated distance in the validity determination.

FIG. 9 is a drawing for describing OCR results, according to an embodiment of the present disclosure.

FIG. 9 (a) shows an image of the inside of a parking lot, which is acquired if a vehicle enters the parking lot. FIG. 9 (b) shows the result of performing OCR on the corresponding image in a vehicle control device.

The vehicle may detect an object corresponding to text in the form of a bounding box (bbox) and a polygon by using the image of (a).

The vehicle may calculate a recognition result (i.e., text information) matching the placed shape and the detected portion with an object or text, which is detected by using the image of (a).

The vehicle recognizes text (e.g., alphabets), numbers, colors, and special text (arrows) and may express the recognized results.

To minimize capacity, the recognized results may be stored inside the vehicle control device in JSON format.

A method in which a vehicle determines validity will be described in detail below. Referring to FIG. 10, the vehicle control device (e.g., the vehicle control device 100 of FIG. 1) may select only valid data such as floor information or pillar information (or zone information) after OCR.

The vehicle control device acquires a predefined character combination of recognized data (e.g., text information of FIG. 5). For example, the vehicle control device may output text including only numbers, text including numbers and letters (e.g., alphabets or Korean letters) in sequence, or text including letters and numbers in sequence.

The vehicle control device determines whether there is text next to an arrow among the acquired text combinations, and excludes the text next to the arrow. A floor located next to an arrow is likely to mean the next floor, and thus the vehicle control device performs categorization such that the floor is not included in the valid text.

The vehicle control device performs a validity check by using a regular expression.

To identify the format of a number expression (i.e., to check whether it is a number alone, a combination of numbers and letters, and whether it includes an arrow), the following regular expressions may be applied.
[Expression 1]
   \hat{ }[\p{L}\p{N}]+$

To determine whether parking floor-related text is included, the vehicle control device may utilize the following regular expression.
[Expression 2]
   \hat{ }[BMGFLP [symbol] ]$

To select only numbers in a certain range (e.g., from −9 to 9, if the number of parking floors is estimated to be less than 10), the vehicle control device may utilize the following regular expression.
[Expression 3]
   \hat{ }−?[\p{Nd}&&[\hat{ }0]]$

As in the above-described method, only floor information may be effectively selected from the recognized data depending on detailed logic. It is desirable that the regular expression should be provided such that it includes all parking lot types.

According to an embodiment, the vehicle control device may apply a weight if selecting information. The vehicle control device may assign the weight to meaningful information based on whether text is detected repeatedly, whether text is placed in a specific location (e.g., a pillar or a ceiling sign), and other information recognized together. Accordingly, the weight may be utilized in validity determination. The validity determination operation includes an operation of calculating a weight for each piece of acquired text information, and an operation of determining validity based on the weight.

FIG. 10 is a flowchart of a method for recognizing a parking location of a vehicle, according to an embodiment.

According to an embodiment, a vehicle control device (e.g., the vehicle control device 100 of FIG. 1) may utilize additional information associated with the type of each parking building to improve the accuracy of parking floor and pillar determination and to assist functions. To this end, the additional information may be built in advance.

In S1010, the vehicle control device acquires information about the type of parking lot in which a vehicle is located. The vehicle control device acquires information about the parking lot type by parsing pre-loaded data if a parking lot is entered, and may utilize the information in determining the information.

In the case of a parking lot of which the parking lot type is not loaded, the vehicle control device may upload the recognized data to an external server.

After performing OCR based on image data in S1020, the vehicle control device acquires text information, and performs a validity determination in S1030.

In S1040, the vehicle control device acquires floor information and/or pillar information among valid data by using the information about a parking lot type. The vehicle control device acquires or classify floor information and/or pillar information from text information based on a predefined display method depending on information about the parking lot type. Hereinafter, to help understand the present disclosure, it is referred to as “pillar information”. However, the pillar information may be identification information provided by a parking operator to identify a parking zone and may also be referred to as “zone information”. If the information utilized by a parking lot user to identify a vertical location of the vehicle is referred to as “floor information”, the information utilized by the parking lot user to identify a horizontal location of the vehicle within a floor may be expressed as pillar information or zone information.

In S1050, the vehicle control device acquires location data corresponding to the text information. The location data corresponding to text information may be location data obtained by matching the acquired floor information and/or the acquired pillar information with the acquired image frame based on a time stamp.

In S1060, the vehicle control device acquires parking location information of the vehicle based on the acquired floor information and/or the acquired pillar information, and the location data of the vehicle.

The vehicle control device may combine or fuse the location data and the floor information and/or the pillar information. Afterwards, the vehicle control device acquires the parking location information based on the combined data.

The floor information and/or the pillar information may be usefully utilized to increase the accuracy of parking location information.

For example, referring again to the recognized text information of FIG. 9, the actual floor number may be M1F, but pillar information such as B2 may be input together. In an image shown in FIG. 9 (a), B2 is pillar information. However, in some cases, depending on a parking lot type, the second basement floor is indicated as B2, and thus it is difficult to identify whether the corresponding information indicates a parking floor or a parking pillar, by using only the text information (B2).

In addition, in FIG. 9 (a), the floor number is M1F, which means a mezzanine. However, if it is unknown whether the mezzanine is present in a specific building, the vehicle control device may mis-determine M1F as 1F. Furthermore, depending on the characteristics of a parking lot, markings for above-ground and underground levels may be different from each other. For example, if there is a lobby, expressions such as G/M/L may be used. The basement may be expressed as −1, B1, 1F, or the like.

To assist such cases, information about building types may be established in advance and utilized as a determination factor for determining data to be adopted and utilized among real-time collected information.

A database (DB) for parking lot types may be established as follows.

The information about parking lot types may be optimized/minimized to add each piece of information as DB attribute information. If the DB attribute information is determined, a method of minimizing and storing information may be utilized as follows.

A method of displaying a ‘parking floor’ is defined in advance. Depending on whether there is a mezzanine, the mezzanine may be expressed as ‘M’, JUNG (in Korean, it means a middle), or ‘X’, and the parking floor may be expressed as the first floor, B2 floor, or the like.

For example, ‘MB0’ is used if there is a mezzanine. It is displayed as ‘M’ and the parking floor is displayed in the format ‘B+number’.

X0 floor is used if there is no ‘mezzanine’. This is a case where the parking floor is displayed in the format of ‘number+‘floor’.

A ‘parking pillar’ is information indicating whether there is pillar information. Moreover, a display method such as a zone display method is defined in advance.

‘X’ indicates that there is no pillar information.

A type with only numbers is displayed as ‘O’; a type with “text+number” is displayed as ‘A0’; and a type with “number+text” is displayed as ‘OA’.

It is desirable that parking lot attribute expressions should be provided such that they includes all parking lot types.

The vehicle control device acquires the parking lot type by parsing the pre-loaded data if a parking lot is entered, uses it for real-time information determination. The vehicle control device uploads the recognized data to a server for a parking lot where the parking lot type is not loaded, and then newly loads DB attribute information based on big data, which is loaded afterwards. The vehicle control device may identify a floor/pillar type based on user feedback for determining whether the answer is correct, after providing a function with internal judgment logic.

FIG. 11 is a flowchart of a method for recognizing a parking location of a vehicle, according to an embodiment.

Referring to FIG. 11, a vehicle control device (e.g., the vehicle control device 100 of FIG. 1) selects an image frame for recognizing a parking location of a vehicle, and may utilize vehicle location data sampled together if selecting the corresponding image frame. The vehicle control device may extract vehicle location information associated with text (e.g., floor information and/or pillar information) extracted from each image frame according to the above-described embodiments.

In S1110, the vehicle control device acquires image data from an external image capturing device, and acquires a plurality of image frames included in the acquired image data by using the image data acquired in S1110. For example, the vehicle control device acquires a plurality of image frames sampled at regular intervals.

In S1120, the vehicle control device acquires pieces of location data as location data while the image data is being captured. The vehicle control device samples vehicle location data acquired if sampling the plurality of image frames. Each vehicle location data may indicate a vehicle location at a time point at which each of the plurality of image frames is captured.

In S1130, the vehicle control device recognizes text included in a plurality of image frames by using the plurality of image frames. The vehicle control device may extract text included in the plurality of image frames, may identify the extracted text, and acquires text information in a form recognizable by the device.

In S1140, the vehicle control device acquires valid text information among the acquired text information. The vehicle control device may extract valid text information from text information acquired from the plurality of image frames acquired while the vehicle is moving.

If extracting the valid text information, the vehicle control device excludes text information (or text information including an arrow) next to an arrow from among the acquired text information and may select text information consisting of a combination of numbers only and a combination of letters and numbers.

Alternatively, the valid text information may be associated with floor and/or pillar information. The valid text information includes at least one piece of valid text information. For example, while the vehicle moves from floor B2 to floor B3, the valid text information among the acquired text information may be B2 and B3. The vehicle control information may divide the acquired valid text information into floors and/or pillars.

In S1150, the vehicle control device acquires at least one valid location data corresponding to the at least one piece of valid text information.

According to an embodiment, the vehicle control information acquires image frame information, from which valid text information is extracted, and acquires location data sampled together if sampling the extracted image frame.

If there are pieces of valid text information, the vehicle control information acquires pieces of image frame information, and acquires pieces of location data sampled together with the extracted plurality of image frames.

For example, if acquiring first valid text information from a first image frame acquired at a first time point and second valid text information from a second image frame acquired at a second time point, the vehicle control device acquires first location data at the first time point, at which the first image frame is sampled, and second location data at the second time point at which the second image frame is sampled.

In S1160, the vehicle control device determines whether the location of the vehicle is changed, based on pieces of valid text information. The vehicle control device determines whether there is a change in valid text information.

According to an embodiment, the vehicle control device determines whether there is a floor change and/or a pillar change based on the pieces of valid text information. Based on valid text information, the vehicle control device determines whether there is a floor change, and determines whether there is a pillar change. Conversely, the vehicle control device may preferentially determine whether there is a pillar change and then determine whether there is a floor change. The vehicle control device determines whether there is a change in the location of the vehicle, based on text information acquired during a certain time section or a certain frame.

In S1170, the vehicle control device determines whether there is a location change based on location data.

For example, the vehicle control device determines whether the vehicle's altitude information (or an altitude value) is changed, if there is a change from floor B2 to floor B3 in the case of a floor, and determines whether the vehicle's latitude and longitude information is actually physically changed if there is a change from pillar A1 to pillar A13 in the case of a pillar.

The vehicle control device determines whether there is a location change (a floor change and/or a pillar change), based on location data during a certain time section or a certain frame.

For convenience of description, the identifying of the location change in S1160 may be referred to as a first location change identifying operation. The identifying of the location change in S1170 may be referred to as a second location change identifying operation.

In S1180, the vehicle control device determines a final floor based on the result of identifying a location change. If the result of identifying a location change based on floor information among the valid text information indicates that there is no change in the floor information, the vehicle control device determines whether a location change (e.g., a difference in an altitude value) satisfies a first threshold value, based on the location data. If the difference in an altitude value does not satisfy the first threshold value (e.g., 1 m) (e.g., if it is less than the first threshold value, or less than or equal to the first threshold value), the vehicle control device determines the corresponding floor as the final floor. The accuracy of GPS sensor values may be affected in underground spaces, and thus the first threshold value may be used.

If there is a change based on the floor information among the valid text information (i.e., if different floor information is continuously recognized according to OCR), the vehicle control device determines whether a difference in an altitude value satisfies a second threshold value based on the location data. If the difference in the altitude value satisfies the second threshold value (e.g., if it is greater than or equal to the second threshold value), the vehicle control device determines that the floor is actually changed. The second threshold value may be greater than the first threshold value. Assuming that the difference in an altitude between parking lots is about 3 m, the second threshold value may be set to about 1.5 m in consideration of a sensor error value range. These parameters may be set differently depending on the design.

If the same information about floor maintenance and floor change is repeated the certain number of times, the vehicle control device determines the corresponding floor as the final floor. If pieces of floor information are continuously the same as each other for five frames based on floor information among valid text information, and an altitude difference for 5 frames is less than a first threshold value based on location data, the vehicle control device determines that the corresponding floor is the final floor.

For example, it is assumed that a first frame, a second frame, a third frame, a fourth frame, and a fifth frame are acquired from the image data, and first text-based location information, second text-based location information, third layer text-based location information, fourth text-based location information, and fifth text-based location information are acquired as floor information among the valid text information for each of the corresponding frames.

Moreover, it is assumed that first location data, second location data, third location data, fourth location data, and fifth location data are acquired as location data for each of the first frame, the second frame, the third frame, the fourth frame, and the fifth frame.

If the acquired first to fifth text-based location information are all the same as each other, and the altitude difference between the first location data and the fifth location data is less than the first threshold value, a floor indicated by the first to fifth text-based location information may be determined as the final floor.

That is, the vehicle control device acquires text information included in a predetermined number of consecutive image frames among the plurality of image frames, and determines whether a location of the vehicle is changed, based on text information included in the predetermined number of consecutive image frames. The vehicle control device acquires location data corresponding to at least two image frames among the plurality of image frames, and determine whether the location of the vehicle is changed, based on the location data corresponding to the at least two image frames. The vehicle control device acquires the parking location information based on the determination result of whether the location of the vehicle is changed based on the text information, and the determination result of whether the location of the vehicle is changed based on the location data.

Although not shown in FIG. 11, the vehicle control device determines a parking pillar (or parking zone) in the above-described method. If the same information as pillar information is repeated the predetermined number of times (e.g., 5 times) if the vehicle control device determines pillar maintenance and pillar change, the vehicle control device determines the corresponding pillar as the final zone. If pieces of pillar information are continuously the same as each other for five frames based on pillar information among the valid text information, and a difference in latitude and longitude for five frames is less than a third threshold value based on location data, the vehicle control device determines the corresponding pillar as the final zone.

For example, it is assumed that the first frame, the second frame, the third frame, the fourth frame, and the fifth frame are acquired from the image data, and first text-based pillar information, second text-based pillar information, third layer text-based pillar information, fourth text-based pillar information, and fifth text-based pillar information are acquired as pillar information among valid text information for each of the corresponding frames.

Moreover, it is assumed that first location data, second location data, third location data, fourth location data, and fifth location data are acquired as location data for each of the first frame, the second frame, the third frame, the fourth frame, and the fifth frame.

If the acquired first to fifth text-based pillar information are all the same as each other, and a difference in longitude and/or latitude between the first location data and the fifth location data is less than the third threshold value, a pillar indicated by the first to fifth text-based pillar information may be determined as the final zone.

In S1180, the vehicle control device may obtain parking location information based on the result of identifying a location change. The parking location information includes floor information determined to be the final floor and zone information determined to be the final zone. The vehicle control device may transmit the acquired parking location information to a user device operating in conjunction with the vehicle control device.

FIG. 12 is an example of an interface that displays parking location information on a user device, according to an embodiment of the present disclosure.

Referring to FIG. 12, a user device (e.g., the user device 130 of FIG. 1) displays a notification message for providing parking location information via a display of the user device. The notification message may be displayed in a form of a pop-up message on an application screen associated with a vehicle.

The application screen for a vehicle includes information about the vehicle owned by a user.

Alternatively, the notification message may be displayed in a form of the pop-up message on the activated screen of the user device.

The vehicle control device may also display the notification message for providing the parking location information via a display that is included in the vehicle and electrically or communicatively connected to the vehicle control device. For example, the vehicle control device displays the notification message in the form of a pop-up message on a screen displayed on the display (e.g., a navigation screen) of the vehicle.

In the meantime, the vehicle control device or the user device (or an application installed thereon) operating in conjunction with the vehicle control device may additionally provide a function to query (save or modify information) whether the provided parking location is correct, so as to verify the accuracy of the provided information and to provide more accurate information to the user.

For example, the vehicle control device displays a pop-up screen including a notification message including parking location information. The pop-up screen including the notification message further includes a selection button for saving or modifying the corresponding parking location information.

For example, the pop-up screen displayed on the vehicle control device or the user device includes a message such as “the current location where the vehicle is parked is B2F in A1 zone” and further includes a selection button for “Save” and/or a selection button for “Modify information” below the message.

According to various embodiments disclosed in the specification, the vehicle control device allows a single vehicle to acquire driving environment information via an image recognition model in an embedded environment and to perform optimal location estimation by fusing only useful information with location data, as a parking location information providing service.

The vehicle control device may apply an OCR model to secure text information in the vehicle driving environment. According to an embodiment of the present disclosure, the vehicle control device may obtain text information via a scenario for effectively operating an OCR model under specific conditions in consideration of memory constraints.

Moreover, the vehicle control device may also acquire the text information via processing after user operation conditions (such as after parking) that require less resource utilization. The vehicle control device may select only valid data from the text information and may derive optimal location estimation results by fusing the selected text information with vehicle location data. Furthermore, to secure the accuracy of estimating location information in a parking environment, it is possible to additionally load types for parking lots and to provide accurate information to customers.

As such, according to embodiments of the present disclosure, the vehicle control device may correct a location in various environments where positioning accuracy is low, such as parking lots, tunnels, and multipaths, by using text information by further utilizing location information. Besides, according to embodiments of the present disclosure, even without a precise map of a parking lot, it is possible to identify parking locations of all arbitrary parking lots, where a user does not drive a vehicle, such as newly built parking lots. According to embodiments of the present disclosure, the vehicle control device may provide a driver who finishes driving with a notification of the identified parking location via a mobile phone, thereby helping the driver who wants to use the vehicle again find the vehicle.

FIG. 13 illustrates a computing system according to an embodiment of the present disclosure.

Referring to FIG. 13, a computing system 2000 includes at least one processor 2100, a memory 2300, a user interface input device 2400, a user interface output device 2500, storage 2600, and a network interface 2700, which are connected with each other via a bus 2200.

The processor 2100 may be a central processing unit (CPU) or a semiconductor device that processes instructions stored in the memory 2300 and/or the storage 2600. Each of the memory 2300 and the storage 2600 includes various types of volatile or nonvolatile storage media. For example, the memory 2300 includes a read only memory (ROM) and a random access memory (RAM).

Accordingly, the operations of the method or algorithm described in connection with the embodiments disclosed in the specification may be directly implemented with a hardware module, a software module, or a combination of the hardware module and the software module, which is executed by the processor 2100. The software module may reside on a storage medium (i.e., the memory 2300 and/or the storage 2600) such as a random access memory (RAM), a flash memory, a read only memory (ROM), an erasable and programmable ROM (EPROM), an electrically EPROM (EEPROM), a register, a hard disk drive, a removable disc, or a compact disc-ROM (CD-ROM).

The storage medium may be coupled to the processor 2100. The processor 2100 may read out information from the storage medium and may write information in the storage medium. Alternatively, the storage medium may be integrated with the processor 2100. The processor and storage medium may be implemented with an application specific integrated circuit (ASIC). The ASIC may be provided in a user terminal. Alternatively, the processor and storage medium may be implemented with separate components in the user terminal.

The above description is merely an example of the technical idea of the present disclosure, and various modifications and variations may be made by one skilled in the art without departing from the essential characteristic of the present disclosure.

Accordingly, embodiments of the present disclosure are intended not to limit but to explain the technical idea of the present disclosure, and the scope and spirit of the present disclosure is not limited by the above embodiments. The scope of protection of the present disclosure should be construed by the attached claims, and all equivalents thereof should be construed as being included within the scope of the present disclosure.

According to an embodiment of the present disclosure, accurate location information may be provided by using text information in various environments such as parking lots, tunnels, and multipaths where positioning accuracy is low.

According to an embodiment of the present disclosure, vehicle parking location information may be provided directly and immediately to the user of a vehicle via data transmission between the vehicle and the user of the vehicle.

According to an embodiment of the present disclosure, a notification path may be formed such that the user of the vehicle may identify vehicle parking location information without a special recognition process of identifying the parking location if the vehicle is parked, thereby providing the user of the vehicle with improved parking experience.

In addition, a variety of effects directly or indirectly understood via the present disclosure may be provided.

Hereinabove, although the present disclosure was described with reference to exemplary embodiments and the accompanying drawings, the present disclosure is not limited thereto, but may be variously modified and altered by those skilled in the art to which the present disclosure pertains without departing from the spirit and scope of the present disclosure claimed in the following claims.

What is claimed is:

1. A vehicle parking location information providing system, the system comprising:
a vehicle including a vehicle control device configured to recognize parking location information of the vehicle;
an image capturing device placed in the vehicle; and
a location measuring device placed in the vehicle,
wherein the vehicle control device is configured to:
acquire image data, which is obtained by capturing at least one exterior of the vehicle, from the image capturing device;
acquire location data from the location measuring device;
acquire a plurality of image frames from the image data;
acquire text information included in the plurality of image frames; and
acquire the parking location information where the vehicle is parked, based on the acquired text information and the acquired location data.

2. The system of claim 1, wherein the vehicle control device is configured to:
transmit the acquired parking location information to a user device operating in conjunction with the vehicle control device.

3. The system of claim 2, wherein the user device operating in conjunction with the vehicle control device is a user device operating in conjunction with a user profile stored in the vehicle control device.

4. The system of claim 1, further comprising:
a display placed inside the vehicle,
wherein the vehicle control device is configured to:
display a message including the acquired parking location information via the display.

5. The system of claim 4, wherein the message including the parking location information further includes a selection button for modifying the parking location information.

6. The system of claim 1, wherein the parking location information includes floor information where the vehicle is parked, and zone information where the vehicle is parked.

7. The system of claim 1, wherein the vehicle control device is configured to:
acquire valid text information associated with at least one of a floor of a parking lot or a zone of the parking lot among the text information; and
acquire the parking location information based on the valid text information and the location data.

8. The system of claim 7, wherein the vehicle control device is configured to:
among the text information, exclude text information including an arrow from the valid text information.

9. The system of claim 7, wherein the vehicle control device is configured to:
acquire driving information of the vehicle and acquire the valid text information based on the driving information; or
acquire information about a type of parking lot where the vehicle is located, and acquire the valid text information based on the information about the type.

10. The system of claim 1, wherein the vehicle control device is configured to:
acquire the text information based on an Optical Character Recognition (OCR) model.

11. The system of claim 10, further comprising:
an illumination sensor placed inside the vehicle,
wherein the vehicle control device is configured to:
activate the OCR model based on data acquired from the illumination sensor.

12. The system of claim 10, wherein the vehicle includes a gear for changing a driving mode, and wherein the vehicle control device is configured to:
activate the OCR model based on a movement of the gear.

13. The system of claim 12, wherein the vehicle control device is configured to:
reversely play the acquired image data while the gear is positioned in a parking mode; and
acquire the plurality of image frames while the image data is reversely played.

14. The system of claim 1, wherein the location data further includes time information, and
wherein the vehicle control device is configured to:
match the location data with the image data by using a time stamp.

15. The system of claim 1, wherein the vehicle control device is configured to:
acquire text information included in a predetermined number of consecutive image frames among the plurality of image frames, and determine whether a location of the vehicle is changed, based on text information included in the predetermined number of the consecutive image frames;
acquire location data corresponding to at least two image frames among the plurality of image frames, and determine whether the location of the vehicle is changed, based on the location data corresponding to the at least two image frames; and
acquire the parking location information based on the determination result of whether the location of the vehicle is changed based on the text information, and the determination result of whether the location of the vehicle is changed based on the location data.

16. A parking location recognizing method performed by a vehicle control device included in a vehicle, the method comprising:
acquiring image data, which is obtained by capturing at least one exterior of the vehicle, from an image capturing device placed in the vehicle;
acquiring a plurality of image frames from the image data;
acquiring text information included in the plurality of image frames;
acquiring location data of the vehicle from a location measuring device placed in the vehicle; and
acquiring parking location information where the vehicle is parked, based on the acquired text information and the location data.

17. The method of claim 16, further comprising:
transmitting the acquired parking location information to a user device operating in conjunction with the vehicle control device.

18. The method of claim 17, wherein the user device operating in conjunction with the vehicle control device is a user device operating in conjunction with a user profile stored in the vehicle control device.

19. The method of claim 16, further comprising:
displaying a message including the acquired parking location information via a display placed in the vehicle.

20. The method of claim 19, wherein the message including the parking location information further includes a selection button for modifying the parking location information.
